(19) United States
(12) Patent Application Publication
(10) Pub. No.: US 2008/0095374 A1
(43) Pub. Date: Apr. 24, 2008

(54) Method And System For Setting Up A Secure Environment In Wireless Universal Plug And Play (Upnp) Networks

(75) Inventor: Oliver Schreyer, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,574

(22) PCT Filed: Aug. 8, 2005
(86) PCT No.: PCT/IB05/52626

§ 371 Date: Feb. 12, 2007

(30) Foreign Application Priority Data
Aug. 16, 2004 (EP) 04103918.1

(51) Int. Cl. H04L 9/08; H04L 9/30

(52) U.S. Cl. 380/282

(57) ABSTRACT

The invention describes a method of setting up a secure environment in wireless Universal Plug and Play (UPnP) networks, comprising a UPnP security console and UPnP controlled devices defined in the UPnP Device Security specification, wherein the entry of information concerning the UPnP security bootstrap as required in the UPnP Device Security specification (particularly an initialization public/private key pair) into the devices is realized via a short-range key transmitter (SKT). A special user-friendly implementation of the UPnP TakeOwnership procedure renders any user interaction other than entering information from a SKT into the devices superfluous. The invention further describes a security system for wireless UPnP networks, comprising a short-range key transmitter (SKT), a security console and a controlled device as defined in the UPnP device security specification.

The invention relates to a method of setting up a secure environment in wireless Universal Plug and Play (UPnP) networks. The invention also relates to a security system for wireless UPnP networks.

The use of wireless communication for supporting mobile devices (such as wireless telephones) or as a substitution for wire-bound solutions between stationary devices (e.g. PC and telephone sockets) has already found a wide application.

For future digital home networks, this means that they typically consist not only of a plurality of wire-bound devices but also of a plurality of wireless devices. When realizing digital wireless networks, particularly home networks, radio technologies such as Bluetooth, DECT and particularly the IEEE802.11 standard for wireless LAN (“Local Area Network”) are used. Wireless communication may also be realized via infrared (IrDa) connections.

Similarly, also other networks employed for information or entertainment of the users may in future also comprise, inter alia, wireless communicating devices. Particularly, ad hoc networks are concerned in this case, which are temporary networks that generally comprise devices owned by different users. An example of such an ad hoc network can be found in hotels. For example, a guest may want to play back music on his own MP3 player via the stereo equipment of the hotel room. Further examples are all kinds of events at which people meet one another and have wireless communicating devices for exchanging data or media content (pictures, movies, music).

For a user-friendly, simple and comfortable network connection of devices of various designs, the Universal Plug and Play (UPnP) architecture was developed on Microsoft's initiative. The UPnP architecture provides the possibility of a substantially administration-free integration of a new device in a UPnP network. The new UPnP device regularly sends messages in a Simple Service Discovery Protocol (SSDP) which can be received by a “control point” within the network. When a new device is detected, the control point can establish contact with this device. When the contact between the device and the control point has been established, both devices exchange their specific properties by means of a device description and one or more service descriptions.

When radio technologies are used in wireless networks, devices such as, for example, an MP3 storage device and a hifi installation can communicate in a wireless manner via radio waves serving as data lines. Principally, there are two modes of operation. The devices either communicate directly from device to device (as a peer-to-peer network), or via a central access point as a distributor station.

Dependent on the standard, the radio technologies have ranges of several tens of meters in buildings (IEEE802.11 up to 30 m) and several hundreds of meters in the open air (IEEE802.11 up to 300 m). Radio waves also penetrate the walls of a dwelling or a house. In the area of coverage of a radio network, i.e. within its range, the transmitted information may be principally received by any receiver which is equipped with a corresponding radio interface.

This necessitates protection of wireless networks from unauthorized or inadvertent interception or hacking of the transmitted information as well as from unauthorized access to the network and hence to its resources.

Methods of access control and protection of the transmitted information are defined in the radio standards (e.g. for IEEE802.11 in “IEEE802.11 Wireless LAN Medium Access Control (MAC) and Physical Layer (PHY) specifications Standard, IEEE”, New York, August 1999, chapter 8). In the end, any form of data security is generally based in radio networks and especially in the IEEE 802.11 standard on secret encryption codes (keys) or passwords which are known to the authorized communication partners only.

Access control involves the ability to distinguish between authorized and unauthorized devices, i.e. a device granting access (for example, an access point or a device in a home network or ad hoc network receiving a communication request) may decide with reference to transmitted information whether a device requesting access is authorized. In media such as radio, which can easily be listened in to, the simple transmission of access codes or the use of identifiers (which the access-granting device can compare with a list of identifiers of authorized devices) is inadequate, because an unauthorized device can unjustly gain access to the required access information by eavesdropping on said transmission.

In the encryption, the transmitted information is encrypted by the transmitting device and decrypted by the receiving device so that the data are of no value to an unauthorized listener or a person who is listening unintentionally.

In addition to “symmetrical” encryption modes (by means of a “shared key”), there is also the public/private key method in which each device provides a generally known key (public key) for encryption and an associated secret key (private key) which is known to this device only and provides the possibility of decrypting the public key-encrypted information.

This provides security of interception without a secret shared key which is known in advance. When using this type of method, however, any arbitrary device can establish a communication with a device (for example, an access-granting device) while using the public key. This therefore also requires authentication for access control which is also based on a secret key that should be known to the communication partners in advance.

To improve data security, network devices may comprise mechanisms for publishing temporary keys, i.e. keys used for encryption for a fixed period of time only, so that not always the same secret key is used. However, the exchange of these temporary keys requires a transmission which is free from interception and also requires at least a first secret key that should be known to the communication partners in advance. The data security by means of encryption is also based on a (first) secret key that should be known to the communication partners in advance.

A security system for wireless networks requires a configuration step of providing a secret key (for authentication and/or encryption) to all relevant devices.

A particular aspect of wireless networks is that these keys should not be transmitted as clear text (unencrypted) via the wireless communication interface, because an unauthorized device might otherwise unjustly get hold of the key by listening in. It is true that coding methods, such as Diffie-Hellman can securely arrange a secret shared key between two communication partners via a radio interface. However, to prevent an unauthorized device from initiating the key arrangement by means of an (access-granting) device of the network, this method must also be coupled to an authentication of the communication partners, which again requires a (first) secret key that should be known to the communication partners in advance.

In wireless telephones in accordance with the DECT standard, a first key has already been stored in the devices (base station and receiver) during their manufacture. When a new receiver is connected to the base station, the key (pin code) stored in the base station must be entered into the new receiver. Since the user should know the key to this end, it is available, for example, on stickers on the base station.

IEEE802.11-based firm or campus networks with a dedicated infrastructure are generally configured by specially trained system administrators. They generally use system management computers which have wire-bound connections to each access point. Via these wire-bound (and thus quasi-secure) connections, the secret keys (for example, WEP keys) are transmitted to the access points. The entry of keys for the clients (e.g. wireless laptops) is performed manually.

It is true that the realization of a configuration step for installing a first secret key is presupposed (and the required configuration steps are defined in software interfaces), but its realization is not fixed. For example, the IEEE802.11 standard comprises the following statement in this respect in chapter 8.1.2: “The required secret shared key is presumed to have been delivered to participating STAs (stations) via a secure channel that is independent of IEEE802.11. The shared key is contained in a write-only MIB (Management Information Base) attribute via the MAC management path.”

The UPnP architecture has its own configuration and security concepts and methods. In accordance with the UPnP specification of the “DeviceSecurityService”, the basis for access control is a security console (SC) which defines access rights to actions of services provided by the devices to be protected (cf UPnP Forum, “UPnP DeviceSecurity:1”, Service Template, 17 Nov. 2003). To this end, the security console “seizes” the device. This means that a standardized procedure follows, by which the security console is entered into the “owner list” of the device.

The standard procedure comprises the following user interaction:
1. The user reads the security ID of the target device (for example, from a sticker on this device, a display or by means of a code card delivered with the device). The security ID is a hexadecimal sequence of characters corresponding to the hash value of the public key of the key pair built in the device, consisting of a public key and a secret key (public/private key).
2. The security console detects the target device (possibly among more devices) via the regular SSDP requests in the UPnP-standardized manner.
3. The security console calls the procedure to “GetPublicKeys” on the target device (in so far as it provides UPnP device security) and thereby acquires the public key of the device.
4. On the basis of the public key, the security console computes the security ID of the device and indicates this to the user on a display in order that he can compare this ID with the security ID read in the first step.
5. The user selects the target device from the list of indicated devices (all of which have delivered a public key to the security console and have not been defined yet by the allocated users) and defines this device.

If, in addition to determining and defining the device to be secured, the user wants the security console to also get security control of the device by “seizing” the device, the above-mentioned operations will be followed by the following steps:
6. The user reads the initiation password from the target device (from its sticker, display or the accompanying code card).
7. The user enters the password into the security console which computes values required for requesting the UPnP “TakeOwnership” procedure.
8. The security console requests the “GetLifetimeSequenceBase” procedure for obtaining the current “SequenceLifetimeBase” value which is necessary for computing further arguments for the UPnP TakeOwnership procedure.
9. The security console requests the UPnP TakeOwnership procedure. The security console is thereby entered into the owner list together with its public key and thus has universal rights, particularly for setting security parameters on the controlled device, which parameters determine the access rights of other (non-owner) devices to the controlled device.

It is a drawback of the above-described UPnP standard procedure that the user must read or gain and enter cryptographic information. These entries are cumbersome and prone to error. If the cryptographic information is entered erroneously, it may be a tedious method.

The invention is to remedy this. It is an object of the invention to provide a special implementation of the UPnP TakeOwnership procedure precluding erroneous entry of cryptographic information and requiring minimal user interaction.

The object of the invention is achieved by a method of setting up a secure environment in wireless Universal Plug and Play (UPnP) networks, in which at least one wireless UPnP device, referred to as “controlled device”, is integrated in a wireless UPnP network comprising at least one device having a UPnP security console functionality, referred to as “security console”, wherein
the security console receives a cryptographic initialization public/private key pair by means of a portable unit via short-range transmission of information, said initialization public/private key pair being stored on said unit and being stored by the security console in addition to a previously stored own private/public key pair,
the controlled device receives the cryptographic initialization public/private key pair from the portable unit via short-range transmission of information, said initialization public/private key pair being stored on said unit and said controlled device storing the hash value of the public key of the initialization key pair in its owner list,
the controlled device subsequently announces itself in the network by means of SSDP in accordance with the UPnP standard procedures, and
after receiving the announcement from the controlled device, the security console gains access to the controlled device by means of the initialization key pair in conjunction with its own key pair by activating the UPnP GrantOwnership function.

Any wireless device of the network (both security console and controlled device) has a receiving unit for receiving a key record from a portable unit. To secure the wireless data traffic between the devices, a secured initial key record is entered into each device, by which these devices acquire a secret shared key with which the encryption and decryption of the transmitted data and/or the authentication is performed. The key record is provided by the key unit of the portable unit which has a transmitter or a combined transmitter with a detector unit for short-range transmission. The key record is thereby entered secure from interception into each wireless device of the network. A key or button on the unit may be used for triggering the transmission of a key record. Dependent on the method used for short-range transmission of information, the transmission of a key record may also be triggered by bringing the unit in the vicinity of the receiving unit and by causing the detector unit to trigger the transmission of the key record.

A method of short-range transmission of information by the portable unit may be based on modulated magnetic or electromagnetic fields as well as on infrared or visible light, ultrasound or infrasound or any other range-controllable transmission technology. The transmission of the key record may also be realized by a multidimensional pattern on the surface of the transmitter, which pattern is read by the receiving unit. It is essential that a technology using a very short range (few centimeters) or a short range and a strong local boundary (e.g. infrared) is used so that the key record is entered from a very short distance and can in no way penetrate the walls of a room.

A particular advantage of this solution is that the entry of the initial key record is very easy and requires substantially no user action. This renders the procedure very comfortable. Nevertheless, it is impossible for unauthorized persons to receive the key record. The transmission of the key record may be triggered by pressing a key on the portable unit or—for example, when using the radio frequency transponder technology (contactless RF tag technology)—also by placing the portable unit in the vicinity of the receiving unit. The entry of the key record into a device is thus very simple and uncomplicated for a user bringing the portable unit in the vicinity of the device (or directing the unit onto the device) and possibly activating a key on the unit. The user neither needs to know anything about the content of the key record or the secret key. An expert for entry and administration of the key record is not necessary.

It is to be noted that the complete initialization key pair (public/private key) is transmitted to all of the new controlled devices, although they actually only require the public key. However, home devices are reliable, and possible abuse of this knowledge is limited to the initialization phase of a new device. After take-over of the ownership of the controlled device, the UPnP security console preferably removes the initialization public/private key pair-generated entry from the owner list of the controlled device by activating the UPnP “RevokeOwnership” function.

In another embodiment of the invention, the initialization key stored on the portable unit only comprises the public key of a key pair which is transmitted to the controlled device. The complete key pair (private/public key) has already been stored in advance on the security console. In this way, the relevant controlled devices only receive the public key. For example, a dealer may deliver the security console together with the portable unit so that the complete initialization key can already be implemented in the security console during its manufacture.

The invention also relates to a security system for wireless UPnP networks, comprising:
a controllable unit with a memory for storing a worldwide unambiguous key record provided for short-range transmission of information of the key record,
at least one device having a UPnP security console functionality with at least one receiving unit comprising a receiver for receiving the key record, and
at least one wireless UPnP device with a receiving unit comprising a receiver for receiving the key record.

The key record preferably includes an initialization private/public key pair by means of which the ownership of a controlled device can be taken over by the UPnP security console.

These and other aspects of the invention are apparent from and will be elucidated with reference to the embodiments described hereinafter.

In the drawing:

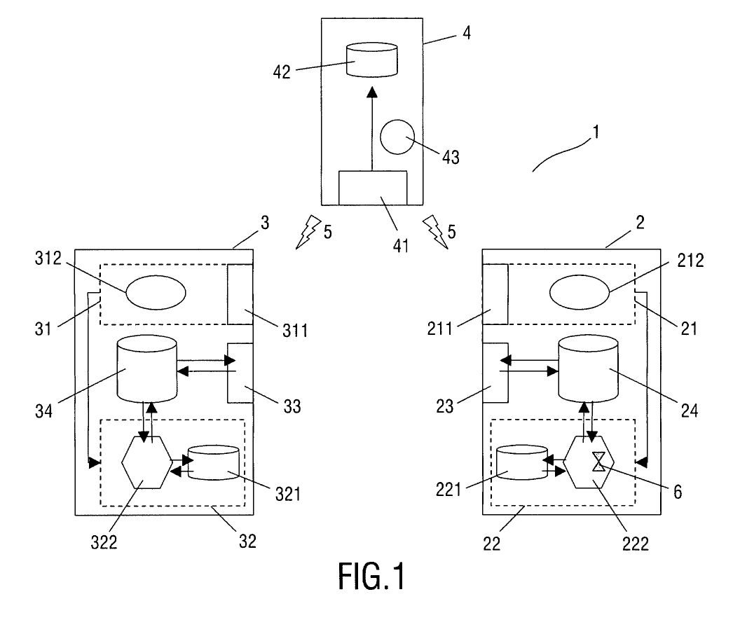

FIG. 1 shows diagrammatically a unit and a security console, as well as a controlled device in a wireless UPnP network.

The UPnP network 1 comprises a device referred to as “security console” having a UPnP security console functionality 3, as well as a new device 2, referred to as “controlled device” which is to be integrated in the network 1 by means of a portable unit 4.

The security console 2 is a UPnP device having a radio interface 23 operating in accordance with the IEEE802.11 standard, which radio interface 23 is used for transmitting useful data (music, video, general data but also control data). Additionally, the security console 2 is equipped with a receiving unit 21. The receiving unit 21 comprises a receiver 211 which is used as an interface for receiving the initialization key record 5 transmitted by the transmitter 41 of the unit 4. The receiving unit 21 comprises receiver software 212 which, after receiving the initialization key record 5 comprising a private/public key pair, stores said key pair in the storage unit 221 of the UPnP security unit 22 in which the manufacturer has already stored an “own” private/public key pair 6. Furthermore, the security unit 22 includes a procedure unit which comprises procedures of the UPnP architecture. The system unit 24 comprises, inter alia, the operating system as well as applications of the device 2.

The unit 4 is used for short-range transmission of information of the initialization key record 5. Essentially, it comprises a storage unit 42 in which the initialization key record 5 has been stored, and a transmitter 41 which is formed as a wireless interface for transmitting the key record 5. In the example of the embodiment, the transmission of the key record 5 is initiated via a key 43 on the unit 4. The transmitter 41 of the unit 4 has a short range of maximally about 10 cm.

The new device 3 to be integrated as a controlled device in the wireless network 1 is also a UPnP device equipped with a radio interface 33 operating in accordance with the IEEE802.11 standard. Additionally, the device 3 is equipped with a receiving unit 31 comprising a receiver 311 used as an interface for receiving the initialization key record 5 transmitted by the transmitter 41 of the unit 4. The receiving unit 31 also comprises receiver software 312 which, after receiving the initialization key record 5, stores this key record in the storage unit 321 of the UPnP security unit 32. Furthermore, the security unit 32 includes a procedure unit which comprises procedures of the UPnP architecture. The system unit 34 comprises, inter alia, the operating system as well as applications of the device 3.

In the UPnP network 1, a device is implemented as a security console 2. The initialization of the security console 2 which does not necessarily need to be known to the user is realized by means of the portable unit 4. After pressing the key 43, the initialization key record 5 stored in the storage unit 42 is transmitted to the receiving unit 21 of the security console 2. The key pair of the data record 5 is stored by the security console 2 in addition to an already available “own” public/private key pair 6 stored by the manufacturer.

When a new device is to be integrated as a controlled device 3 in the wireless UPnP network 1, the device 3 is initialized by means of the unit 4, with the initialization key record 5 being transmitted between the transmitter 41 and the receiver 311. After the key record 5 has been received, the device 3 stores the hash value of the public key of the key record 5 as the “initial owner” in an “owner list” in the storage unit 321 of the UPnP security unit 32. This corresponds to a “concise version” of the UPnP TakeOwnership procedure, but without any special user interaction.

Subsequently, the device 3 announces itself in the network 1 via SSDP in accordance with the UPnP standard. When the security console 2 receives the announcement from the new device 3, it gains access to the controlled device 3 via the UPnP GrantOwnership function by means of the initialization key record 5 and its own public/private key pair 6 stored by the manufacturer.

1. A method of setting up a secure environment in wireless Universal Plug and Play (UPnP) networks, in which at least one wireless UPnP device (3), referred to as “controlled device”, is integrated in a wireless UPnP network (1) comprising at least one device having a UPnP security console functionality, referred to as “security console” (2), wherein
the security console (2) receives a cryptographic initialization public/private key pair (5) by means of a portable unit (4) via short-range transmission of information, said initialization public/private key pair being stored on said unit (4) and being stored by the security console (2) in addition to a previously stored own private/public key pair (6),
the controlled device (3) receives the cryptographic initialization public/private key pair (5) from the portable unit (4) via short-range transmission of information, said initialization public/private key pair being stored on said unit and said controlled device storing the hash value of the public key of the initialization key pair in its owner list,
the controlled device (3) subsequently announces itself in the network by means of SSDP in accordance with the UPnP standard procedures, and
after receiving the announcement from the controlled device (3), the security console (2) gains access to the controlled device by means of the initialization key pair (5) in conjunction with its own key pair (6) by activating the UPnP GrantOwnership function.

2. A method as claimed in claim 1, characterized in that, after take-over of the ownership of the controlled device (3), the UPnP security console (2) removes the initialization public/private key pair-generated entry from the owner list of the controlled device (3) by activating the UPnP RevokeOwnership function.

3. A method as claimed in claim 1, characterized in that the initialization key (5) stored on the portable unit (4) only comprises the public key of a private/public key pair, which public key is transmitted to the controlled device (3), and in that the complete key pair has already been stored in advance in the security console (2).

4. A security system for wireless UPnP networks, comprising:
a controllable unit (4) with a memory (42) for storing a worldwide unambiguous key record (5) provided for short-range transmission of information of the key record (5),
at least one device having a UPnP security console functionality (2) with at least one receiving unit (21) comprising a receiver (211) for receiving the key record (5), and
at least one wireless UPnP device (3) with a receiving unit (31) comprising a receiver (311) for receiving the key record (5).

5. A security system as claimed in claim 4, characterized in that the key record (5) comprises an initialization public/private key pair by means of which the ownership of a controlled device (3) can be taken over by the UPnP security console (2).
